(19) United States
(12) Patent Application Publication
(10) Pub. No.: US 2026/0303472 A1
(43) Pub. Date: Oct. 1, 2026

(54) METHODS FOR DYNAMIC AI/ML COLLABORATION WITH ML MODEL DELIVERY

(71) Applicant: InterDigital Patent Holdings, Inc., Wilmington, DE (US)

(72) Inventors: Jung Je Son, Warrington, PA (US); Ulises Olvera-Hernandez, Saint-Lazare (CA); Michel Roy, Candiac (CA); Alec Brusilovsky, Downingtown, PA (US); Guanzhou Wang, Brossard (CA); Taimoor Abbas, Sainte-Julie (CA)

(73) Assignee: InterDigital Patent Holdings, Inc., Wilmington, DE (US)

(21) Appl. No.: 19/093,175

(22) Filed: Mar. 27, 2025

(51) Int. Cl. H04L 41/16; G06N 20/00; H04W 8/24; H04W 28/02

(52) U.S. Cl. CPC H04L 41/16; G06N 20/00; H04W 8/24; H04W 28/0236

(57) ABSTRACT

A wireless transmit/receive unit (WTRU), may receive, from a network, a first request for information associated with data collection and AI/ML model capabilities for performing a collaborative analytic service. The collaborative analytic service may be associated with an AI/ML model identified by an analytic service identifier (ID). The WTRU may send a response to the first request. The response may comprise the information associated with data collection and the AI/ML model capabilities for performing the collaborative analytic service. The WTRU may receive a second request to perform the collaborative analytic service using the AI/ML model identified by the analytic service ID. The second request may comprise AI/ML collaboration level information associated with the AI/ML model identified by the analytic service ID. The AI/ML collaboration level information may indicate how the AI/ML model identified by the analytic service ID may be configured and/or trained at the WTRU.

### BACKGROUND

Radio access network (RAN) herein may refer to a radio access network based on the fifth generation (5G) radio access technology (RAT). RAN may also refer to evolved universal terrestrial radio access (E-UTRA) that may connect to the next generation (NextGen) core network. FIG. 2 depicts a reference model of a potential architecture of a 5G or NextGen network. The access control and mobility management function (AMF) 204 may include the following functionalities: registration management, connection management, reachability management, and/or mobility management, etc. The session management function (SMF) 208 may include the following functionalities: session management (including session establishment, modify, and/or release), a user equipment (UE), internet protocol (IP) address allocation, and/or selection and/or control of a user plane (UP) function (UPF) 212, etc. The UPF 212 may include the following functionalities: packet routing and/or forwarding, packet inspection, and/or traffic usage reporting, etc.

### SUMMARY

A wireless transmit/receive unit (WTRU), may receive, from a network, a first request for information associated with data collection and artificial intelligence or machine learning (AI/ML) model capabilities for performing a collaborative analytic service. The collaborative analytic service may be associated with an AI/ML model identified by an analytic service identifier (ID). The WTRU may send a response to the first request. The response may comprise the information associated with data collection and the AI/ML model capabilities for performing the collaborative analytic service. The WTRU may receive a second request to perform the collaborative analytic service using the AI/ML model identified by the analytic service ID. The second request may comprise AI/ML collaboration level information associated with the AI/ML model identified by the analytic service ID. The AI/ML collaboration level information may indicate how the AI/ML model identified by the analytic service ID may be configured and/or trained at the WTRU. The WTRU may send, to the network, results of inference performed using the AI/ML model identified by the analytic service ID.

The WTRU may train the AI/ML model identified by the analytic service ID based on the collaboration level information. The WTRU may receive the AI/ML model identified by the analytic service ID based on the collaboration level information.

The WTRU may send, to a model training server, data for AI/ML model training based on the analytic service ID and the AI/ML collaboration level. The WTRU may receive, from the model training server, an AI/ML model ID. The AI/ML model ID is based on the received data for AI/ML model training and on the analytic service ID.

The AI/ML model capabilities may comprise one or more of a list of supported analytic service IDs, a list of AI/ML models associated with each analytic service ID, an indication of supporting a configurable AI/ML model, an indication of supporting ML model download, an indication of supporting data transfer to the network or a third party server for model training, and/or an indication of supporting a collaborative AI/ML model.

The information associated with data collection may comprises one or more of a location of the WTRU, a channel quality, frequency, and/or a weather condition. The AI/ML collaboration level information may be valued by no AI/ML collaboration, AI/ML collaboration based on the AI/ML model preconfigured within the WTRU, AI/ML collaboration based on an AI/ML model downloaded to the WTRU and AI/ML model training is performed on the WTRU, and/or AI/ML collaboration based on an AI/ML model downloaded to the WTRU and AI/ML model training is performed by an entity other than the WTRU.

The WTRU may register the one or more features for data collection or the AI/ML model capabilities with an AI/ML repository before the network sends the first request.

An AI/ML collaboration server may send, to an AI/ML repository, a first request for a list of one or more candidate WTRUs. The first request may comprise an analytic service identifier (ID) and/or capabilities of the one or more candidate WTRUs for performing collaborative analytic service. The AI/ML collaboration server may receive a first response to the first request, the first response comprising a list of candidate WTRUs comprising the analytic service ID and the capabilities of the one or more candidate WTRUs for performing collaborative analytic service. The AI/ML collaboration server may send, to a candidate WTRU from the list of candidate WTRUs, a second request for information associated with information associated with data collection and AI/ML model capabilities for performing collaborative analytic service.

The AI/ML collaboration server may receive, from the candidate WTRU, a second response to the second request. The second response may comprise the information associated with data collection and/or the AI/ML model identified by the analytic service ID.

The AI/ML collaboration server may determine an AI/ML model for collaborative analytic service based on the one or more of features for data collection and the AI/ML models capable for supporting the AI/ML model identified by the analytic service ID. The AI/ML collaboration server may send, to the candidate WTRU, a third request to perform collaborative analytic service using the AI/ML model identified by the analytic service ID. The third request comprises AI/ML collaboration level information associated with the AI/ML model identified by the analytic service ID. The AI/ML collaboration level information indicates how the AI/ML model identified by the analytic service ID is configured or trained at the WTRU.

The AI/ML collaboration server may receive, from the candidate WTRU, results of inference performed using the AI/ML model identified by the analytic service ID. The AI/ML collaboration server may compute analytics information based on the received results of inference. The AI/ML collaboration server may send the computed analytics information to a service consumer.

The first request may further comprise one or more of a network slice, a data network name (DNN), a time period for data collection for inference, a list of WTRU candidates, a service area, and/or an application identifier (ID).

The first response further comprises one or more of a list of supported analytic IDs, a list of AI/ML models per analytic ID with associated information, an indication of supporting configurable AI/ML models, an indication of supporting AI/ML model download, an indication of supporting data transfer to a network or a third party server for model training, and/or an indication of supporting collaborative AI/ML models.

The AI/ML collaboration server may send, to the candidate WTRU, an AI/ML collaboration level based on a type of AI/ML model associated with the analytic service ID. The AI/ML model capabilities comprise one or more of a list of supported analytic service IDs, a list of AI/ML models associated with each analytic service ID, an indication of supporting a configurable AI/ML model, an indication of supporting ML model download, an indication of supporting data transfer to the network or a third party server for model training, and/or an indication of supporting a collaborative AI/ML model.

The information associated with data collection may comprise one or more of a location of the WTRU, a channel quality, frequency, and/or a weather condition.

The AI/ML collaboration server may receive an analytics service request from the service consumer, wherein the consumer request comprises one or more of quality of service (QoS) requirements, requirements for accuracy, or latency.

The analytics service request may further comprise additional parameters associated with the target analytic service, the additional parameters comprising one or more of requested NW slice information, a requested data network name (DNN), a requested time period for data collection for inference, a requested service area, requested list of UE(s), and/or an application identifier (ID).

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 depicts a diagram of a reference model of a fifth generation/next generation (5G/NextGen) network.

FIG. 3A depicts a diagram of a procedure of artificial intelligence or machine learning (AI/ML) collaboration between a wireless transmit/receive unit (WTRU)/RAN node and core network (CN).

FIG. 3B depicts a continuation of the diagram of a procedure of artificial intelligence or machine learning (AI/ML) collaboration between a wireless transmit/receive unit (WTRU)/RAN node and core network (CN).

FIG. 4A depicts a diagram of a procedure of an (AI/ML) collaboration between the WTRU and the RAN for WTRU side model training.

FIG. 4B depicts a continuation of the diagram of a procedure of an (AI/ML) collaboration between the WTRU and the RAN for WTRU side model training.

FIG. 5A depicts a diagram of a procedure AI/ML collaboration among the WTRU, the RAN and the network (NW) for two-sided model training.

FIG. 5B depicts a continuation of the diagram of a procedure AI/ML collaboration among the WTRU, the RAN and the network (NW) for two-sided model training.

### DETAILED DESCRIPTION

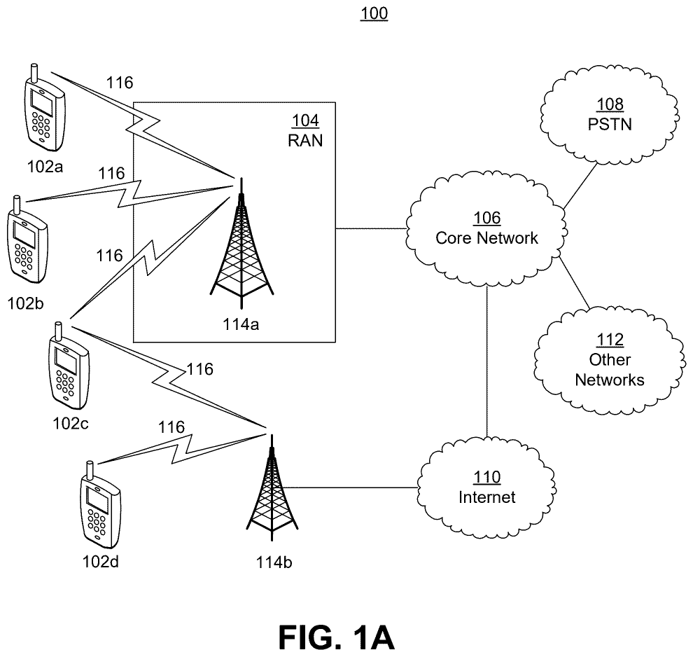

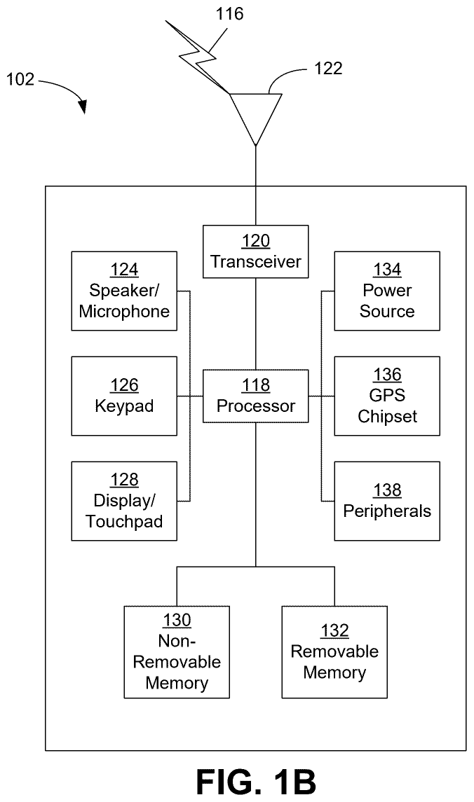

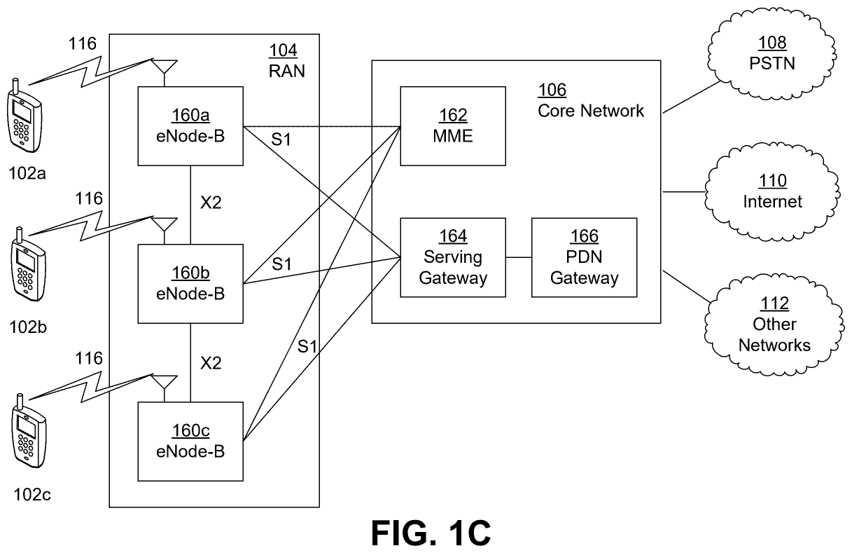

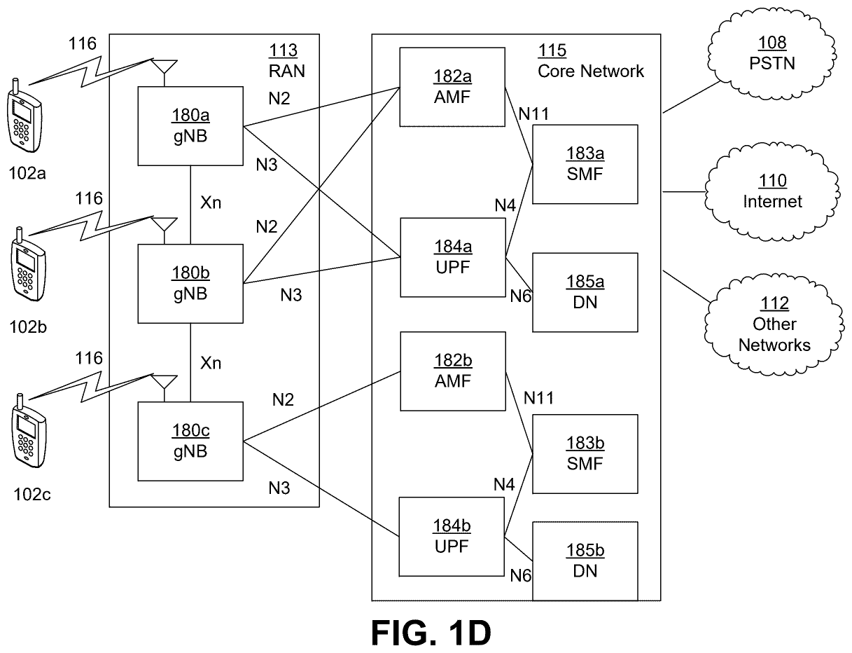

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

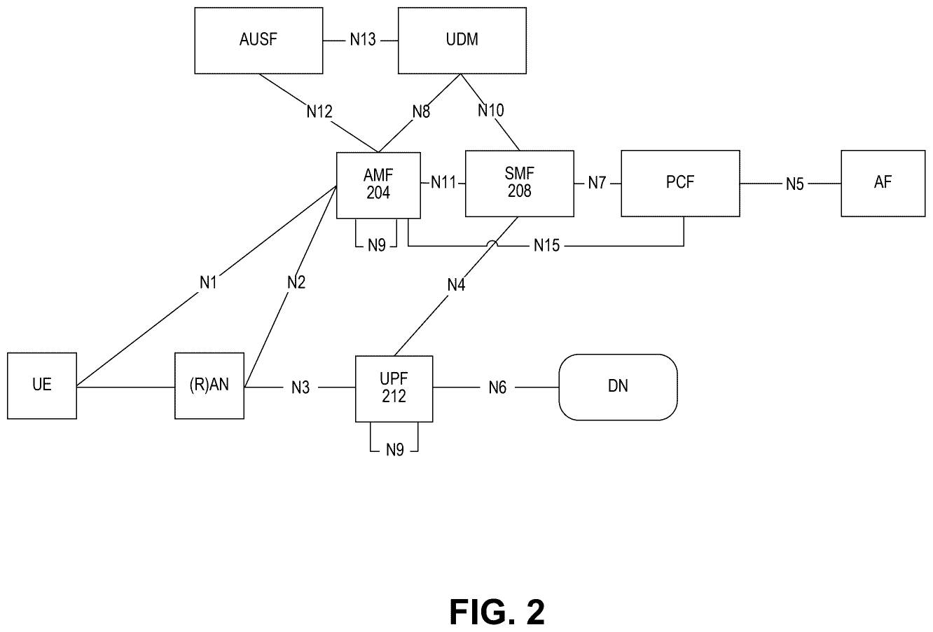

Radio access network (RAN) herein may refer to a radio access network based on the fifth generation (5G) radio access technology (RAT). RAN may also refer to evolved universal terrestrial radio access (E-UTRA) that may connect to the next generation (NextGen) core network. FIG. 2 depicts a reference model of a potential architecture of a 5G or NextGen network. The access control and mobility management function (AMF) 204 may include the following functionalities: registration management, connection management, reachability management, and/or mobility management, etc. The session management function (SMF) 208 may include the following functionalities: session management (including session establishment, modify, and/or release), a user equipment (UE)—also known and/or referred to as a wireless transmit/receive unit (WTRU)—internet protocol (IP) address allocation, and/or selection and/or control of a user plane (UP) function (UPF) 212, etc. The UPF 212 may include the following functionalities: packet routing and/or forwarding, packet inspection, and/or traffic usage reporting, etc.

The Network Data Analytics service may provide statistics and/or predictions based on specific requests from the entities consuming this information. Information provided by the Network Data Analytics service may include statistics and/or predictions on gNB status information, gNB resource usage, and/or communication and/or mobility performance in an area of interest. The target of such analytics may comprise of a single WTRU, a group of WTRUs, and/or any WTRU that may be in an area of interest. The Network Data Analytics service may provide analysis on statistics and/or predictions regarding WTRU mobility, expected WTRU behavior, and/or an observed service experience at multiple levels (e.g., per network (NW slice), per application, and/or per access type, etc.).

A Network Data Analytics service may be provided by a NW data analytics function (NWDAF) in 5GC. A NWDAF may register to a network repository function (NRF) one or more of the following: its supported analytics identifier (ID), possibly per service, which may indicate a kind of network data analytics service, e.g., slice load level related network data analytics. The observed service experience may be related network data analytics, including federated learning amongst multiple NWDAFs, etc.

NWDAF may contain following functions: an analytics logical function (AnLF). The AnLF may be a logical function in NWDAF, which performs inference, derives analytics information (e.g. derives statistics and/or predictions based on Analytics Consumer request), and/or exposes analytics service.

The NDWAF may also contain a model training logical function (MTLF). A logical function in NWDAF, the MTLF may train machine learning (ML) models. The MTLF may expose new training services (e.g. providing trained ML model). The MTLF may provide trained ML Models to the AnLF. The NWDAF may decide whether to use horizontal or vertical federated learning for training ML models.

In 3GPP, there exist several studied frameworks of artificial intelligence or machine learning (AI/ML) over air interfaces for one-sided models and/or two-sided models. One-sided models refer to an AI/ML model whose inference is performed entirely at an entity (e.g., WTRU). Two-sided models refer to paired AI/ML models over which joint inference is performed. Joint inference may comprise an AI/ML whose inference is performed jointly across the WTRU and/or the network.

For different use scenario (e.g., CSI feedback enhancement, beam management, and/or positioning accuracy enhancement), several levels of collaboration between WTRU and/or NW are studied for AI/ML operation involving the WTRU. These collaboration levels aim to provide more efficient environment of AI/ML operation for the WTRU having limited computing power and/or limited memory capacity.

The collaboration levels may be differentiated per model storage location (e.g., inside 3GPP NW and/or outside 3GPP NW), training location (WTRU-side, NW-side, and/or neutral site), and/or model delivery (model delivery over the top, model delivery in proprietary format, and/or model delivery in open format).

The AI/ML collaboration levels may be associated with certain values, ranks, and/or indicators. For example, an AI/ML collaboration of level 0 may mean no AIML collaboration. Level 1 may mean AIML collaboration based on ML model preconfigured within WTRU (e.g., NW may utilize ML inference result by the WTRU but the ML model cannot be configured by NW.) Level 2 may mean AIML collaboration based on configurable ML model from NW downloaded to WTRU and/or ML model training is within WTRU (e.g., no data sharing from WTRU to other entity for training.) Level 3 may mean AIML collaboration based on configurable ML model from the NW downloaded to WTRU and data sharing from WTRU to other entity for ML model training (e.g., after ML model training by the NW or third-party server and WTRU download trained ML model for collaboration).

Model delivery to the WTRU is a key aspect for collaboration. Based on a different scenario, different ML models with different features may be needed at the WTRU side. However, due to limitation of storage and/or computing power, every model may not be preloaded and/or trained in the WTRU.

Many use cases utilizing AI/ML and/or involving collaboration between a WTRU and/or NW may enhance existing mobile communication services. The level of achievement by AI/ML operation for a use case may be different per location, time, and/or environment, etc.

Each use case may have different key performance identifier (KPI) requirements. For example, for a use case utilizing beam management, may consider reducing latency in beam management as an important goals. Accordingly, when working with a use case utilizing beam management, latency for data collection in model inference may be one of the KPIs. For another example, positioning, model inference latency may be a critical factor for beam management. However, model inference may be one factor representing model capability.

If the WTRU requires high accuracy of analytic services, based on the results, the ML model may need to be updated. This may mean that level 2 and/or level 3 of the AI/ML collaboration level described above may be desirable when model update is desired for optimization. If the WTRU requires low latency, level 1 and/or level 2 may be desirable in order to reduce the latency from time of request to time of actual analytic result provided.

Considering these aspects, when applying AI/ML operation involving WTRU and/or NW for some use cases, there may not be a single collaboration level that works with every mobile terminal and/or with different environments. Therefore, to achieve better performance with AI/ML operation, consideration of proper collaboration levels between WTRU and/or NW may be applied.

For developing many use cases with AI/ML collaboration, a dynamic configuration of AI/ML collaboration may be desired. Based on the configuration, the ML model may be selected, managed, and/or used. There may be a need to coordinate the model selection and/or management in collaborative with AI/ML use cases.

A collaborative AI/ML use case may be where a first model is used for inferencing on a first node (e.g., a WTRU) and/or a second model is used for inferencing on a second node (e.g., a gNB). Both the first model and the second model need to be used in conjunction for obtaining coherent predictions on the first and/or second node. In other words, predictions on a first node may need to be coherent with predictions on a second nod. The coherence in predictions may be achieved by using a pair of ML models that are associated.

Achieving coherence in prediction may be desired if different models are used for inferencing on different nodes, and nodes are expected to be coherent with predictions. A need to exchange model information across different nodes may be unclear.

Described herein is the means for a mobile system (e.g., RAN, NW, and/or WTRU) that may perform AI/ML collaboration in a dynamic manner to achieve better service quality of service (QoS) using AI/ML operation.

A solution may be a procedure for AI/ML collaboration between the WTRU and/or the RAN node (e.g., referenced as the WTRU/RAN node) and the core network (CN) for one-side model training. From the WTRU/RAN's perspective, the WTRU may engage with registration of AI/ML capability. The WTRU may receive information of supported feature and/or supported ML model for collaborative analytic service. The WTRU may monitor an environment for evaluating availability of data collection for requested features. The WTRU may respond to available features and/or supported ML model for collaborative analytic service. The WTRU may receive a request for collaborative analytic service including AI/ML collaboration level. The WTRU may, according to indicated AI/ML collaboration level, transfer data for ML model training if needed. The WTRU may, according to indicated AI/ML collaboration level, download and/or receive ML model from a ML model repository. The WTRU may train the ML model unless the WTRU received trained ML model. The WTRU may perform ML model inference as configured by AI/ML collaboration server. The WTRU may send result of ML model inference to the AI/ML collaboration server.

From the AI/ML collaboration server's perspective, the AI/ML collaboration server may receive a request for analytic service form a service consumer. The AI/ML collaboration server may determine ML model and/or AI/ML collaboration (with WTRU and/or with RAN node). The AI/ML collaboration server may discover WTRU and/or RAN node for the determined analytic service with AI/ML collaboration. The AI/ML collaboration server may receive WTRU/RAN node's status and/or determine candidate WTRU/RAN node for AI/ML collaboration. The AI/ML collaboration server may send a request for information of supported features and/or ML model to the candidates. The AI/ML collaboration server may receive a response with supported features for data collection and support ML models. The AI/ML collaboration server may determine ML model with features for AI/ML collaboration and/or determine WTRU/RAN node for AI/ML collaboration. The AI/ML collaboration server may determine AI/ML collaboration level per WTRU/RAN node's capability and/or determined ML model and/or features. The AI/ML collaboration server may send a request for collaborative analytic service with AI/ML collaboration level. The AI/ML collaboration server may receive a result of ML model inference. The analytic information returned from the WTRU/RAN to the AI/ML collaboration server may be the output of the AI/ML model or may be derived at the AI/ML collaboration server. In some cases, the analytic information may be inference results. The AI/ML collaboration server may derive analytic information. The AI/ML collaboration server may send a response with analytic information to the consumer.

A solution may be a procedure for AI/ML collaboration between the WTRU and RAN for WTRU-side model training. From the WTRU node's perspective, the WTRU may engage in registration of AI/ML capability. The WTRU may receive information of supported feature and/or supported ML model for collaborative analytic service. The WTRU may monitor environment for evaluating availability of data collection for requested features. The WTRU may respond available features and/or supported ML model for collaborative analytic service. The WTRU may receive a request for collaborative analytic service including AI/ML collaboration level. The WTRU may according to indicated AI/ML collaboration level, transfer data for ML model training if needed. The WTRU may, according to indicated AI/ML collaboration level, download and/or receive ML model from ML model repository. The WTRU may train ML model unless WTRU received trained ML model. The WTRU may perform ML model inference as configured by AI/ML collaboration server. The WTRU may send result of ML model inference to the AI/ML collaboration server.

From the RAN node's perspective, the RAN may receive a request for analytic service. The RAN may determine ML model and/or AI/ML collaboration (with WTRU). The RAN may discover WTRU for the determined analytic service with AI/ML collaboration. The RAN may determine candidate WTRU for AI/ML collaboration. The RAN may send a request for information of supported features and ML model to the candidates. The RAN may receive a response with supported features for data collection and support ML models. The RAN may determine ML model with features for AI/ML collaboration and determine WTRU for AI/ML collaboration. The RAN may determine AI/ML collaboration level per WTRU's capability and determined ML model and/or features. The RAN may send a request for collaborative analytic service with AI/ML collaboration level. The analytic information returned from the WTRU/RAN to the AI/ML collaboration server may be the output of the AI/ML model or may be derived at the AI/ML collaboration server. In some cases, the analytic information may be inference results. Based on the inference from WTRU/RAN, further analytics (e.g., any difference at the historical trends) and/or additional information in other aspects (e.g., per time or area and/or some environmental conditions) may be added at the analytic result from the AI/ML collaboration server. The RAN may receive results of ML model inference. Based on the inference from WTRU/RAN, further analytics (e.g., any difference at the historical trends) and/or additional information in other aspects (e.g., per time or area and/or some environmental conditions) may be added at the analytic result from the AI/ML collaboration server. The RAN may derive analytic information. The RAN may send a response with analytic information to the consumer.

A solution may be a procedure for AI/ML collaboration among the WTRU, RAN, and NW for two-sided model training (in WTRU and RAN). From the WTRU/RAN node's perspective, the WTRU/RAN may engage in registration of AI/ML capability. The WTRU/RAN may receive information of supported feature and supported ML model for collaborative analytic service. The WTRU/RAN may monitor environment for evaluating availability of data collection for requested features. The WTRU/RAN may respond to available features and/or supported ML model for collaborative analytic service. The WTRU/RAN may receive a request for collaborative analytic service including AI/ML collaboration level. The WTRU/RAN may, according to indicated AI/ML collaboration level, transfer data for ML model training if needed. The WTRU/RAN may, according to indicated AI/ML collaboration level, download and/or receive ML model from ML model repository. The WTRU/RAN may train ML model unless WTRU received trained ML model. The WTRU/RAN may perform ML model inference as configured by AI/ML collaboration server. The WTRU/RAN may send result of ML model inference to the AI/ML collaboration server.

From the AI/ML collaboration server's perspective, the AI/ML collaboration server may receive a request analytic service. The AI/ML collaboration server may determine a two-sided ML model and/or AI/ML collaboration (with WTRU and RAN node). The AI/ML collaboration server may discover WTRU and RAN node for the determined analytic service with AI/ML collaboration. The AI/ML collaboration server may receive WTRU's status and/or determine candidate WTRU and/or RAN node for AI/ML collaboration. The AI/ML collaboration server may send a request for information of supported features and ML model to the candidates. The AI/ML collaboration server may receive a response with supported features for data collection and support ML models. The AI/ML collaboration server may determine ML model with features for AI/ML collaboration and determine WTRU and/or RAN node for AI/ML collaboration. The AI/ML collaboration server may determine AI/ML collaboration level per WTRU and RAN node's capability and determined ML model and/or features. The AI/ML collaboration server may send a request for collaborative analytic service with AI/ML collaboration level. The AI/ML collaboration server may receive result of ML model inferences from WTRU and RAN node. The analytic information returned from the WTRU/RAN to the AI/ML collaboration server may be the output of the AI/ML model or may be derived at the AI/ML collaboration server. In some cases, the analytic information may be inference results. Based on the inference from WTRU/RAN, further analytics (e.g., any difference at the historical trends) and/or additional information in other aspects (e.g., per time or area and/or some environmental conditions) may be added at the analytic result from the AI/ML collaboration server. The AI/ML collaboration server may derive analytic information. The AI/ML collaboration server may send a response with analytic information to the consumer.

For AI/ML collaboration, there may be different aspects to consider for deciding the collaboration level. The AI/ML collaboration may be adaptable to WTRU's different environmental contexts (e.g., per location and/or time, per number of WTRU's, and/or per service etc.). The AI/ML collaboration may be adaptable WTRU's capability to support AI/ML to maintain the performance above some required level (e.g., defined by min and/or max QoS thresholds). QoS requirements for NW analytic (e.g., latency, accuracy, and/or reliability etc.) may be satisfied. For different use cases, different KPIs may be used as QoS (e.g., beamforming and/or location have different latency requirements). The KPIs for AI/ML collaboration may include performance, latency, computational complexity, overhead, and/or power consumption, etc. For better performance, updating the existing ML model and/or applying a different ML model for collaboration may be possible.

Herein, an AI/ML collaboration server is defined. Based on different deployment scenario and/or different AI/ML collaboration case, the AI/ML collaboration server may be implemented in a NF (e.g., NWDAF and/or location management function (LMF)) or a gNB or as an application enablement function (e.g., AI/ML enablement server) or as separate entity (e.g., application function (AF)).

Based on the registered WTRU's capabilities and/or QoS requirement in the received service request, the AI/ML collaboration server may determine the AI/ML collaboration level. The determined AI/ML collaboration level may indicate how the ML model for collaboration is configured within the WTRU (e.g., using a preconfigured ML model that is already in the WTRU or using the network-configured ML model delivered to the WTRU, etc.). The determined AI/ML collaboration level may further indicate how the WTRU's ML model for collaboration may be trained (e.g., ML model may be trained within the WTRU, and/or the ML model may be trained at NW or at a 3rd party server).

When the AI/ML collaboration level indicates the configured ML model delivered to the WTRU, the information on how the model is delivered may be included. When AI/ML collaboration level may indicate the ML model training may be performed at the NW or third-party server, the information as to how the data for ML model training is performed may be included.

When the WTRU registers to the NW, the WTRU may include its capability for AI/ML collaboration. The capability for AI/ML collaboration may include a list of analytic services that are available with AI/ML collaboration. For each supported analytic service, identified by an analytic service ID, the WTRU may include its supported ML model with associated supported feature information. For each analytic service and/or supported ML model, the associated feature information may be preconfigured and/or configure upon successful registration, given the capability of AI/ML collaboration is provided.

The WTRU may register different AI/ML capability in terms of how configurable ML model is supported. For example, the WTRU may execute downloaded ML model within some size. The WTRU may use preloaded ML model, but the WTRU may adjust its size within some range, or it may support only preloaded ML model processing at a fixed size. The WTRU may register its support to download a model from NW and/or execute it. The WTRU may register its support of data transfer to the NW and/or third-party server for ML model training.

The procedure of AI/ML collaboration between WTRU/RAN node and CN for one-side model training (e.g., either WTRU or RAN) is described herein. An AI/ML collaboration server may reside in the core network (CN) as a network function (NF). For a one-sided model (e.g., either WTRU or RAN), the AI/ML collaboration server may communicate with a WTRU or a RAN for one-sided model training and/or delivery. Depending on a collaboration level, model training may be performed within a WTRU and/or a RAN node or may be performed by ML model training server (e.g., outside of a WTRU and/or a RAN node). Depending on a collaboration level, model delivery may be downloaded from a ML model repository by a WTRU or a RAN node.

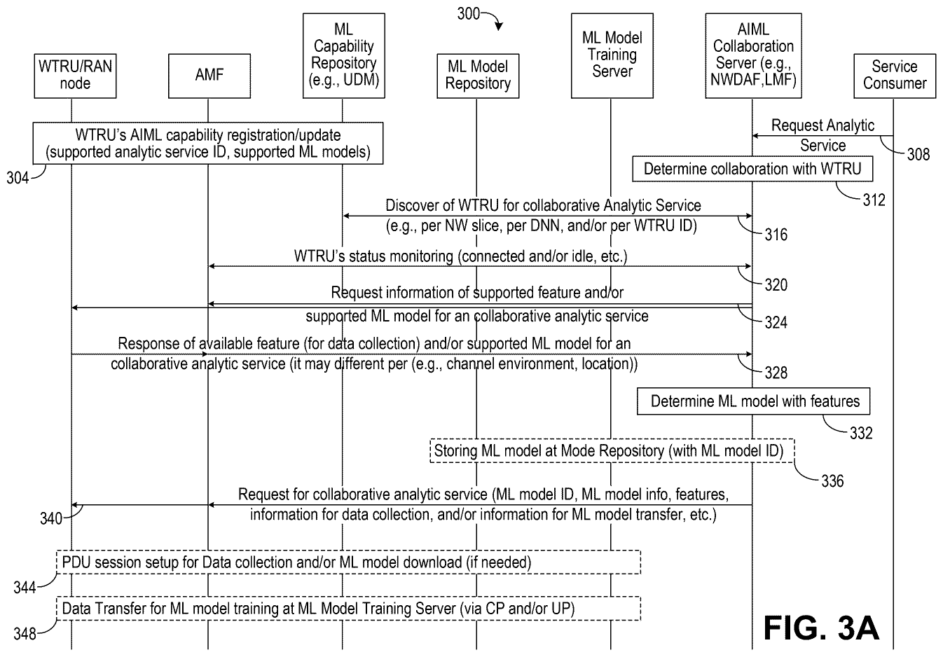

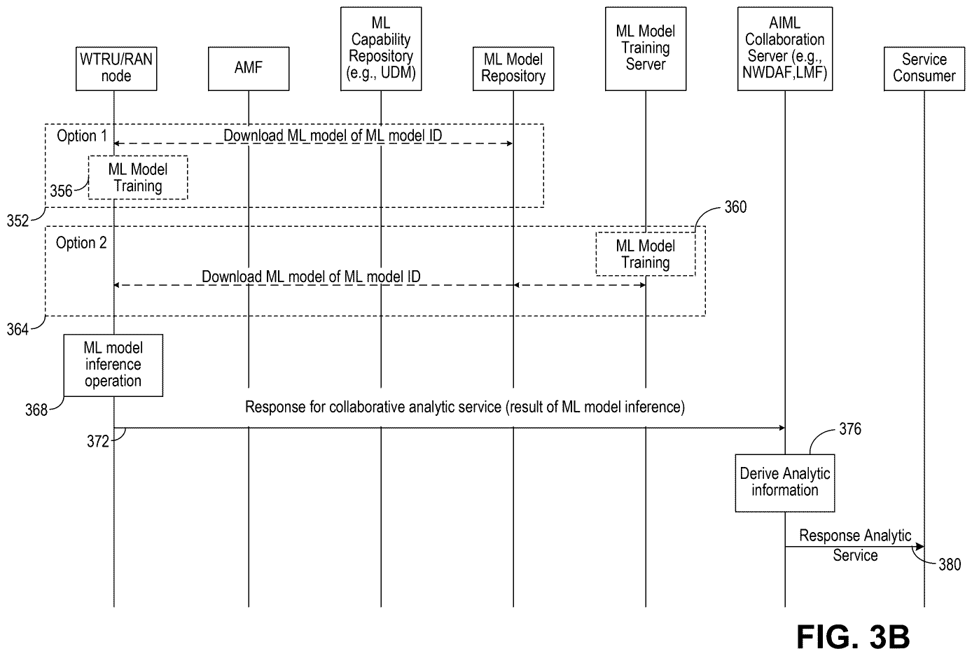

FIG. 3 depicts a diagram 300 of a procedure of AI/ML collaboration with the WTRU/RAN node and CN for one-sided model training. At 304, the WTRU may register its AI/ML capability to the ML capability repository. The registration may be performed during registration to the NW. For example, when the WTRU may send a registration request to AMF, the request may include ML capability. The AMF may send the WTRU's ML capability to ML capability repository. The ML capability repository may be co-located with a NF (e.g., AMF, unified data management (UDM) and/or AI/ML enablement server, and/or ML model repository) or may be located as independent NF.

The WTRU's registered ML capability may include a list of supported analytic identifiers (ID), ML models per analytic ID with associated information (e.g., feature information), an indication of supporting configurable ML model, an indication of supporting ML model download, an indication of supporting data transfer to NW or third-party server for model training, and/or an indication of supporting collaborative AI/ML models.

Similarly, a RAN node may register ML capability in ML capability repository (e.g., via operations, administration, and maintenance (OAM) or via N2 connection with an AMF and/or the AMF may register it in the ML capability repository) with a list of supported analytic IDs, ML models per analytic ID with associated information (e.g., feature information), an indication of supporting configurable ML model, an indication of supporting ML model download, an indication of supporting data transfer to NW and/or third party server for model training, and/or an indication of supporting collaborative AI/ML models.

At 308, service consumers may send an analytic service request to the AI/ML collaboration server. A gNB, AF, and/or NF may send analytic service requests as a service consumer. If an AF is a nontrusted third party entity, the AF may send a request through NEF.

The analytic service request may include the requested analytic service ID with QoS requirement, requirements for accuracy, and/or latency, etc. The request may also include additional parameters to specify target analytic service such as requested NW slice information, requested data network name (DNN), requested time period for data collection for inference, requested service area, requested list of WTRU(s), and/or requested application information (e.g., application ID).

The analytic service request from consumer may include an indication whether consumer may provide ML model for the requested analytic service and how the model may be downloaded (e.g., using URL, URI, endpoint, and/or an IP address) an indication whether ML model may be trained on behalf of the WTRU, and/or how the model training may be performed (e.g. using URL, URI, endpoint, IP address of model training server, and/or requested data information). For example, the AF may include ML model download information for a specific ML model repository to be used by the WTRU. The AF may include ML model training server information for a specific ML model training server.

At 312, for the requested analytic service ID in the received request at 308, AI/ML collaboration server may determine an AI/ML collaboration with WTRU. For example, the AI/ML collaboration server may determine an AI/ML collaboration with WTRU based on configured ML model for the requested analytic service ID and/or based on received ML model information for the requested analytic service ID at 308.

At 316, the AI/ML collaboration server may send a request for the discovery of WTRU/RAN node for the AI/ML collaboration server. The request may include the requested NW slice, requested DNN, requested list of WTRUs, and/or requested service area. In other words, the AI/ML collaboration server may discover WTRU(s) and/or RAN node(s) supporting collaborative AI/ML models in a requested area.

When ML capability repository is managed per service area (e.g., co-located with AMF per AMF service area), AI/ML collaboration server may identify target ML capability repository based on requested service area and/or based on WTRU's registration area when requested list of WTRUs included. As a response to the request, the server may receive the list of candidate WTRUs and/or RAN node(s) for AI/ML collaboration for the requested analytic service ID and/or WTRU's ML capability information.

At 320, after receiving list of candidate WTRUs for AI/ML collaboration, AI/ML collaboration server may contact NFs (e.g., each WTRU's serving AMF or UDM) to gather WTRU's status information (e.g., connected state or idle state, subscribed PLMN, frequency, etc.).

The WTRU's status information may be included in the information received from the ML capability repository in 316. This information from the WTRU may be conveyed to the AMF either over a protected interface (e.g., non-access stratum (NAS) and/or protected for integrity, replay, and/or for confidentiality (e.g., optionally). Based on WTRU's status information, the server may update the list of candidate WTRUs.

At 324, the server may send a request for information on supported features (e.g., dataset features) for data collection for the requested analytic service ID. The request may include the requested ML model for the requested analytic service ID. This information from the AMF may be conveyed to the WTRU/RAN node either over a protected interface (e.g., NAS or N2 session) or protected for integrity, replay, and/or for confidentiality (e.g., optionally).

At 328, after receiving the request, the WTRU/RAN node may respond with list of available features for data collection for the requested ML model. If the requested ML model is not included in the request, the WTRU/RAN node may respond with supported ML model for the requested analytic service ID and/or a list of available features for data collection for each supported ML model. At 328, WTRU may consider user consent for collaboration for an analytic service, ML model, and/or features for data collection which may be transferred to other entity (e.g., ML model training server, etc.).

Per the WTRU's circumstance (e.g., location, channel qualities, frequency, and/or weather, etc.), some feature may not be available for data collection. Those features not available for data collection may not be included in the list of available features for data collection.

At 332, the server may determine ML model with features for the requested analytic service ID and determine AI/ML collaboration level and/or list of target WTRUs/RAN Node(s) (e.g., based on the received feature list available for data collection and/or indication whether configured ML model is supported).

The determined AI/ML collaboration level may be decided according to the requested analytic service information with additional information (e.g., ML model download and/or training from third party server), configured ML model for each analytic ID, and/or the capability of WTRU/RAN Node (e.g., ML model, feature list, and/or support of configured ML model).

In an example, the AI/ML collaboration server may utilize preconfigured ML model collaboration levels (e.g., an indication whether ML model may be downloaded, an indication whether ML Model training for the WTRU/RAN Node may be performed outside WTRU) and/or WTRU/RAN node's capability for the decided AI/ML collaboration level.

If the WTRU/RAN node may execute any ML model configurable, the AI/ML may consider transferring a customized ML model to the WTRU/RAN Node (e.g., via control plane (CP), user plane (UP) connection, and/or via N2 connection, etc.). The WTRU/RAN node may update the model dynamically per WTRU/RAN node's condition.

If the WTRU/RAN node may execute only pre-configured ML model with some features, the collaboration level with the WTRU/RAN node may be to utilize the WTRU/RAN node's preconfigured ML Model for inference. When some of features for the requested analytic service is not supported in the preconfigured ML model of WTRU/RAN node, the WTRU/RAN node may not be selected by the server. The server may update the list of features based on the supported feature by WTRU/RAN node received in 328.

At 336, when the decided AI/ML collaboration level includes the delivery of the configured ML model to the WTRU/RAN node, the server may assign an ML model ID to indicate the decided ML model for AI/ML collaboration with a WTRU. The server may store the ML model at the ML model repository with ML model ID. This way, the WTRU/RAN node may download the configured ML model using ML model ID from ML model repository.

At 340, the server may send a request for AI/ML service. The request may include requested analytic service ID for ML inference and AI/ML collaboration level. The request may include ML model information for the analytic service ID. When the ML model is downloaded, the ML model ID and/or information for ML model delivery (e.g., server IP address, ML model repository's address, and/or relevant PDU session information if the model is downloaded via UP, etc.) may be included together. When the ML model is trained outside the WTRU/RAN node, information for data collection (e.g., ML model training server's address, relevant PDU session information if transferred via UP, time information for data collection, etc.) may be included together. In the request, for ML model inference, the requested time for the data collection on ML model inference may be included.

As another embodiment, WTRU/RAN node may receive separate requests for ML model training and/or ML model inference. In this case, after WTRU/RAN node downloads the ML model from the ML model repository using the ML model ID, WTRU/RAN node may receive another request for ML model inference. The request may include time for data collection on ML model inference. This information from the AMF may be conveyed to the WTRU/RAN Node either over a protected interface (e.g., NAS and/or N2 connection) or protected for integrity, replay, and/or for confidentiality (e.g., optionally).

At 344, if the ML model is downloaded via UP or training data transfer is performed via UP, an associated protocol data unit (PDU) session may be established.

At 348, the WTRU/RAN node may send training data to the ML model training Server (via CP and/or UP) based on configuration at 340.

As option 1, in 352, the WTRU/RAN node may download the ML model with a ML model ID from the ML model repository if indicated in 340. In step 356, the WTRU/RAN node may perform ML model training for the requested analytic service ID. In this case, the WTRU/RAN node may use a preconfigured ML model inside or a downloaded ML model from the ML model repository as configured in 340.

When downloading the AI model over the air, the download proceeds either over a protected interface (e.g., NAS) or separately protected for integrity, replay, and/or confidentiality (e.g., optionally).

As option 2, in 360, the ML model training server may train the ML model with a ML model ID. The ML model ID may be assigned for the WTRU/RAN node using the data transferred in 348. The trained ML model may be updated in ML model repository with the ML model ID. After training, at 346, WTRU/RAN Node may download the ML model with ML model ID from the ML model repository, if indicated in 340.

At 368, the WTRU/RAN node may perform ML model inference based on the request at 340. At 368, the WTRU/RAN node may collect data in the requested time for data collection on ML model inference and use the collected data for ML model inference.

At 372, the WTRU/RAN node may respond to the AI/ML Collaboration Server with ML with the inference result for the requested analytic service ID in 340. When sending the response over the air, the response may be sent either over a protected interface (e.g., NAS) or separately protected for integrity, replay, and/or confidentiality (e.g., optionally).

At 376, based on the WTRU/RAN Node's inference result, the AI/ML collaboration server may derive analytic information for the requested analytic service by the service consumer.

At 380, the analytic information may be provided to the service consumer as a response to the analytic service request.

The procedure of AI/ML collaboration between WTRU and RAN for WTRU side model training is described herein. RAN node (e.g., a gNB) may work as an AI/ML collaboration server. For one-sided model (e.g., at the WTRU), the RAN node as AI/ML collaboration server may communicate with WTRU for one-sided model training and/or delivery. For two-sided model (e.g., at the WTRU and/or the RAN node), the RAN node as an AI/ML collaboration server may communicate with WTRU for WTRU sided model training. The RAN node may handle inside for RAN side model training. After receiving ML model inference result from WTRU, the RAN node may derive analytic result using WTRU's inference result and/or RAN's inference result inside RAN.

For WTRU side model training, depending on a collaboration level, the model training may be performed within WTRU and/or may be performed by ML model training server (e.g., outside of WTRU). For WTRU side model delivery, depending on a collaboration level, the model delivery may be downloaded from ML model repository by WTRU. In this case, the solution herein describes how the AI/ML collaboration procedure may be performed between WTRU and/or RAN nodes as an AI/ML collaboration server.

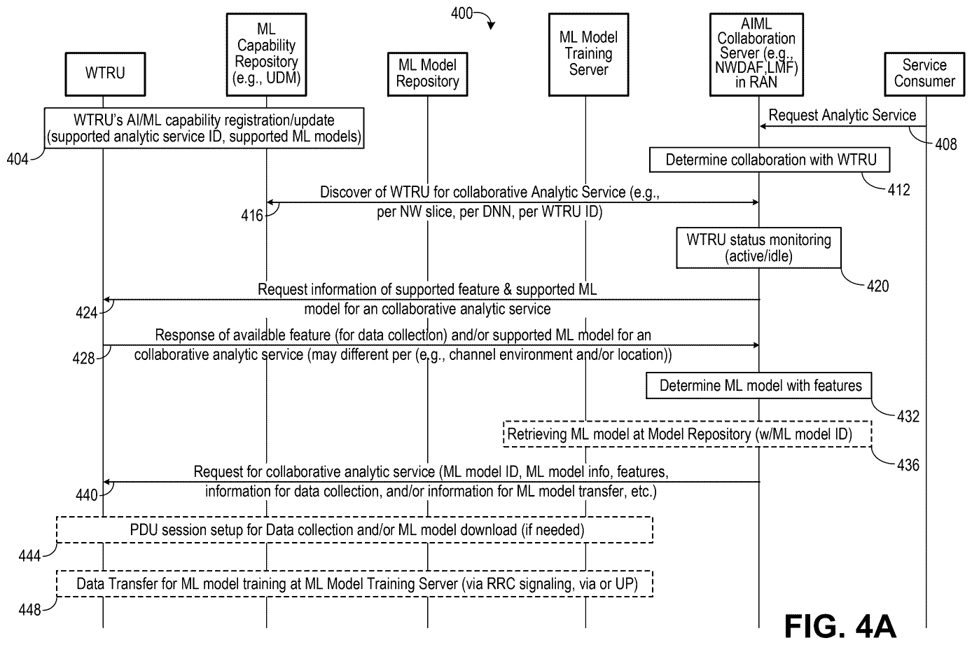

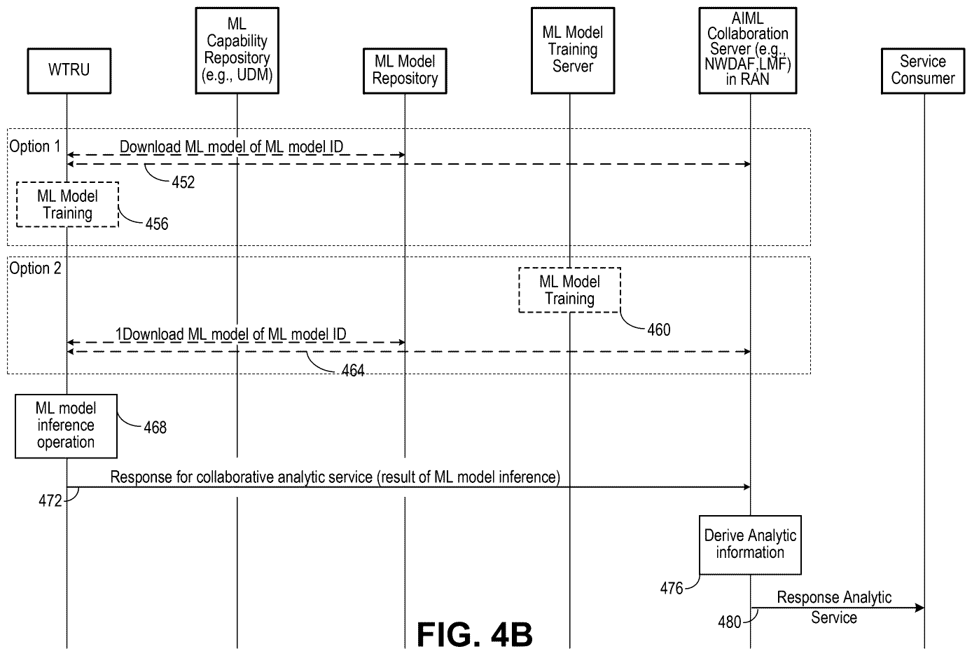

FIG. 4 depicts a diagram 400 of a procedure of AI/ML collaboration between the WTRU and the RAN for WTRU side model training. At 404, the WTRU may register its AI/ML capability to the ML capability repository. The registration may be performed during registration to the NW. For example, when the WTRU sends a registration request to AMF, the WTRU may include ML capability. An AMF may send a WTRU's ML capability to the ML capability repository. The ML capability repository may be collocated with NF (e.g., AMF and/or UDM) and/or may be used as separate NF.

The WTRU's registered ML capability may include a list of supported analytic IDs, ML models per analytic ID with associated information (e.g., feature information), an indication of supporting configurable ML model, an indication of ML model download, an indication of data transfer to NW or third-party server for model training, and/or an indication of supporting collaborative AI/ML models.

At 408, service consumers may send an analytic service request to the RAN node as an AI/ML collaboration server. A gNB, AF, and/or NF may send analytic service requests as a service consumer.

The analytic service request may include the requested analytic service ID with QoS requirement. QoS requirements may include requirements for accuracy and/or latency, etc. QoS requirements may include additional parameters to specify target analytic service such as requested NW slice information, requested DNN, requested period for data collection for inference, requested service area, and/or requested list of WTRU(s), requested application information (e.g., application ID).

An analytic service request may include indication of model download and model training. For example, an AF may include model download from a server for configured ML model for the WTRU. The AF may include model training from a server.

At 412, for the requested analytic service ID in the received request at 408, the RAN node as an AI/ML collaboration server may determine AI/ML collaboration with the WTRU. For example, RAN node may determine AI/ML collaboration with the WTRU based on the configured ML model for the requested analytic service ID and/or based on received ML model information for the requested analytic service ID at 408.

At 416, the RAN node as an AI/ML collaboration server may send a request for discovery of WTRU for AI/ML collaboration service. The request may include a requested list of WTRUs. As a RAN node is working as AI/ML collaboration server, the RAN node may query information on the WTRUs served by RAN node. As a response to the request, the RAN node as an AI/ML collaboration server may receive WTRU's ML capability information for the requested list of WTRUs.

At 420, after receiving a list of candidate WTRUs for AI/ML collaboration, the RAN node as an AI/ML collaboration server may verify WTRU's connection status (e.g., connected state or idle state, etc.). Based on WTRU's status information, the RAN node as an AI/ML collaboration server may update the list of candidate WTRUs.

At 424, the RAN node as an AI/ML collaboration server may send a request for information of supported feature for the requested analytic service ID (e.g., via a RRC message). The request may include requested ML model for the requested analytic service ID.

At 428, after receiving the request, WTRU may respond with list of available features for data collection for the requested ML model (e.g., via a RRC message). If the requested ML model is not included in the request, the WTRU may respond with a supported ML model for the requested analytic service ID and/or list of available features for data collection for each supported ML model.

Per the WTRU's circumstance (e.g., location, channel qualities, frequency, and/or weather, etc.), some features may not be available for data collection. Those features not available for data collection may not be included in the list of available features for data collection.

At 432, the RAN node as an AI/ML collaboration server may determine ML model with features for the requested analytic service ID and/or determine AI/ML collaboration level and/or list of target WTRUs (e.g., based on the received feature list available for data collection and/or indication whether configured ML model is supported).

The AI/ML collaboration level may be determined according to the requested analytic service information with additional information (e.g., indication whether ML model download and/or training from third party server), configured ML model for each analytic ID, and/or the capability of WTRU (e.g., ML model, feature list, and/or support of configured ML model).

In an example, the RAN node as an AI/ML collaboration server may utilized pre-configured ML model collaboration level (e.g., indication whether ML model may be downloaded, and/or indication whether ML Model training for the WTRU may be performed outside the WTRU) and/or the WTRU's capability to decide AI/ML collaboration level.

If the WTRU may execute any ML model dynamically configurable, the RAN node as an AI/ML server may consider customized ML model transfer to the WTRU and/or any dynamic updates per the WTRU's condition.

If the WTRU may execute only pre-configured ML model with some features, the collaboration level with the WTRU may be to utilize the WTRU's preconfigured ML model for inference. When some of features for the requested analytic service is not supported in the preconfigured ML model of WTRU, the WTRU may not be selected by the server. The server may update the list of features based on the supported feature by WTRU received at 428.

At 436, when the decided AI/ML collaboration level include the delivery of the configured ML model to the WTRU, the RAN node as an AI/ML collaboration server may assign an ML model ID for the decided ML model to be used in AI/ML collaboration with the WTRU. The RAN node, as an AI/ML collaboration server, may retrieve the decided ML model with the supported feature from the ML model repository.

As another embodiment, the server may inform the ML model repository of the assigned ML model ID and the decided ML model with the supported feature. In this case, the WTRU may download the ML model using the ML model ID from the ML model repository. Using this ML model ID, the ML model training server may access the ML model for training data on behalf of WTRU.

At 440, the RAN node as an AI/ML collaboration server may send a request for AI/ML service. The request may include requested analytic service ID for ML inference and AI/ML collaboration level. The request may include ML model information for the analytic service ID. When the ML model is to be downloaded, the ML model ID, and information for ML model delivery (e.g., server IP address, ML model repository's address, and/or relevant PDU session information if downloaded via UP etc.) may be included together. When the ML model is trained outside the WTRU, information for data collection (e.g., ML model training server's address, relevant PDU session information if transferred via UP, time information for data collection, etc.) may be included together. In the request for ML model inference the requested time for data collection on ML model inference may be included.

In an example, after 440, the RAN Node as an AI/ML collaboration server may send the ML model which received from ML model repository to the WTRU. In another example, the WTRU may receive separate request for ML model training and/or ML model inference. In this case, after the WTRU downloads the ML model from ML model repository using the ML model ID, the WTRU may receive another request for ML model inference. The request may include time for data collection on ML model inference.

At 444, if the ML model is downloaded via UP and/or training data transfer is performed via UP, an associated PDU session may be established, if needed. In another example, when the ML model is to be downloaded, information for ML model delivery may be provided to the WTRU from other NF (e.g., SMF) during PDU session setup and/or after PDU session setup. Similarly, information for data collection outside the WTRU may be provided to the WTRU from other NF during PDU session setup and/or after PDU session setup.

At 448, the WTRU may send training data to the ML model training server (e.g., via CP, UP, and/or radio bearer) based on received configuration (e.g., at 440.)

As option 1, at 452, the WTRU may receive the ML model from ML model repository or from the RAN Node as AI/ML collaboration server (e.g., via UP and/or radio bearer, etc). And at 456, the WTRU may perform ML model training for the requested analytic service ID. In this case, the WTRU may use preconfigured ML model inside the WTRU or downloaded ML model from ML model repository as configured at 440.

As option 2, at 460, ML model training server may train ML model with a ML model ID. The model ID may be assigned for the WTRU node using the data transferred in at 448. The trained ML model may be updated in ML model repository with the ML model ID. The trained ML model may be retrieved by the RAN node as an AI/ML collaboration server. After training, at 464, the WTRU may download and/or receive the trained ML model with ML model ID from the ML model repository and/or from the RAN node as an AI/ML collaboration server, as configured at 440.

At 468, the WTRU may perform ML model inference based on the request at 440. At 468, the WTRU may collect data in the requested time for data collection on ML model inference and/or use the collected data for ML model inference.

At 472, the WTRU may respond to the RAN node as an AI/ML collaboration server with ML inference result for requested analytic service ID in 440.

At 476, based on WTRU's inference result, the RAN node as an AI/ML collaboration server may derive analytic information for the requested analytic service by service consumer. If a two-sided model is applied for the requested analytic service, the RAN Node may derive the analytic result based on WTRU's inference result. The RAN side's inference result may be based on the WTRU's inference result and/or any other form of integration of the result, etc.

At 480, the analytic information may be provided to service consumer as response to the analytic service request.

The procedure of AI/ML collaboration among the WTRU, the RAN, and the NW for two-sided model training (e.g., in the WTRU and/or the RAN) is described herein. The AI/ML collaboration server may reside in CN as a NF. For a two-sided model (e.g., the WTRU side and/or RAN side), the AI/ML collaboration server may communicate with WTRU and/or RAN for two-sided model training and/or delivery. Depending on a collaboration level, model training may be performed within WTRU and/or RAN node or may be performed by the ML model training server (e.g., outside of the WTRU and/or the RAN node). Depending on a collaboration level, model delivery may be downloaded from ML model repository by WTRU and/or RAN node.

For a two-sided model, depending analytic service, ML model inference by WTRU and ML model inference by RAN Node may be integrated by AI/ML collaboration server. For different analytic service, the ML model inference by WTRU and/or RAN node may be utilized as input for ML model inference by the RAN node or the WTRU, respectively, to derive analytic information.

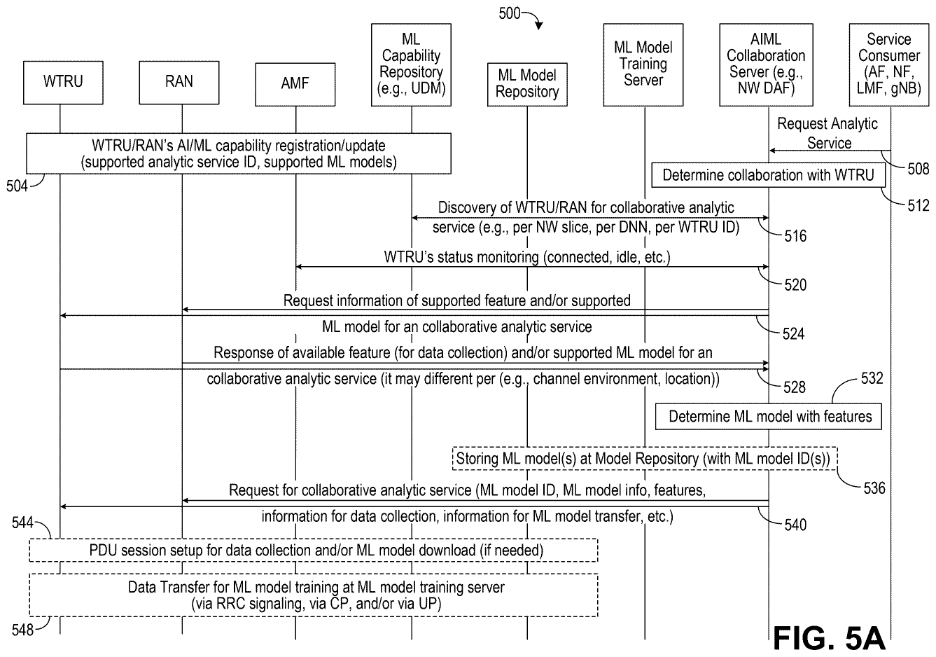

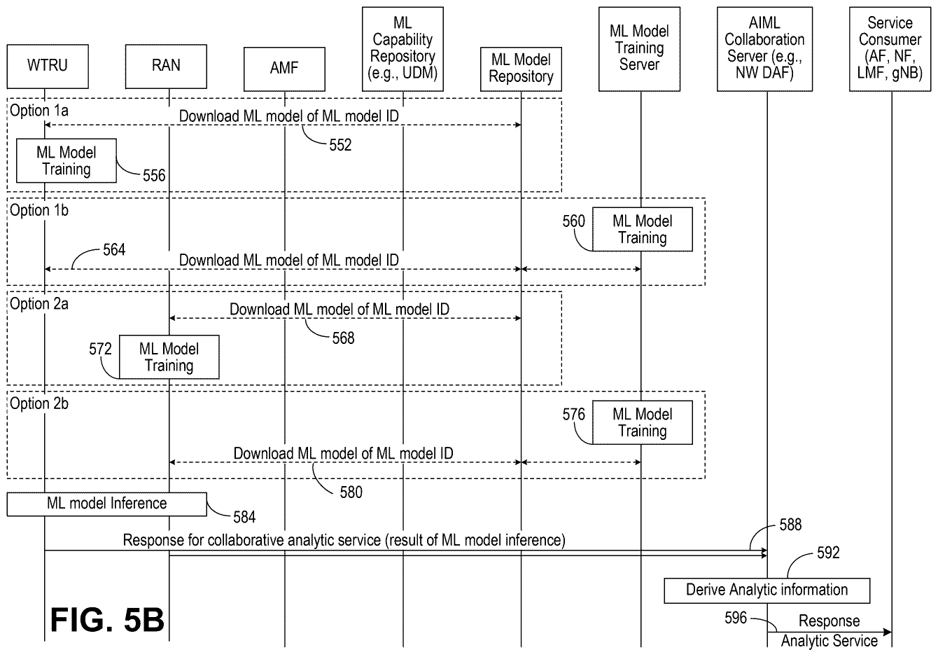

FIG. 5 depicts a diagram of a procedure AI/ML collaboration among the WTRU, the RAN and the network (NW) for two-sided model training. At 504, the WTRU may register its AI/ML capability to the ML capability repository. The registration may be performed during registration to the NW. For example, when the WTRU sends a registration request to AMF, the registration may include ML capability, and/or the AMF may send a WTRU's ML capability to the ML capability repository. The ML capability repository may be co-located with a NF (e.g., AMF, UDM, AI/ML enablement server, and/or ML model repository) and/or may be located as independent NF.

The WTRU's registered ML capability may include a list of supported analytic ID, ML models per analytic ID with associated information (e.g., feature information), an indication of supporting configurable ML model, an indication of supporting ML model download, an indication of supporting data transfer to a NW or a third-party server for model training, and/or an indication of supporting collaborative AI/ML models.

Similarly, a RAN node may register ML capability in the ML capability repository. The Ran node may register via OAM and/or via N2 connection with AMF. The AMF may then register the ML capability in the ML capability repository with a list of supported analytic ID, ML models per analytic ID with associated information (e.g., feature information), an indication of supporting configurable ML model, an indication of supporting ML model download, an indication of supporting data transfer to the NW or third party server for model training, and/or an indication of supporting collaborative AI/ML models.

At 508, the service consumer may send an analytic service request to AI/ML collaboration server. A gNB, AF, and/or NF may send analytic service request as a service consumer. If AF is a nontrusted third party entity, then the AF may send a request through a NEF.

The analytic service request may include the requested analytic service ID with QoS requirement, requirements for accuracy, and/or latency, etc. The analytic service request may also include additional parameters to specify target analytic service, such as requested NW slice information, requested DNN, requested period for data collection for inference, requested service area, requested list of WTRU(s), and/or requested application information (e.g., application ID).

The analytic service request from the consumer may include an indication of whether the consumer may provide ML model for the requested analytic service and/or how the model may be downloaded (e.g., using URL, URI, endpoint, and/or IP address). The analytic service request may indicate whether the ML model may be trained on behalf of the WTRU. The analytic service request may indicate how the model training may be performed (e.g., using URL, URI, endpoint, IP address of model training server, and/or requested data information). For example, an AF may include ML model download information for a specific ML model repository to be used by the WTRU. The AF may include ML model training server information for a specific ML model training server.

At 512, for the requested analytic service ID in the received request at 508, AI/ML collaboration server may determine an AI/ML collaboration with the WTRU. For example, the AI/ML collaboration server may determine an AI/ML collaboration with the WTRU based on configured ML model for the requested analytic service ID or based on received ML model information for the requested analytic service ID at 508.

At 516, the AI/ML collaboration server may send a request for the discovery of WTRU/RAN node for the AI/ML collaboration service. The request may include the requested NW slice, requested DNN, requested list of WTRUs, and/or requested service area. In other words, the AI/ML collaboration server may discover WTRU(s) and/or RAN node(s) supporting collaborative AI/ML models in a requested area.

When ML capability repository is managed per service area (e.g., co-located with AMF per AMF service area), the AI/ML collaboration server may identify target ML capability repository based on requested service area or based on WTRU's registration area when requested list of WTRUs included. As a response to the request, the server may receive the list of candidate WTRUs and/or RAN node(s) for AI/ML collaboration for the requested analytic service ID and WTRU's ML capability information.

At 520, after receiving list of candidate WTRUs for AI/ML collaboration, the AI/ML collaboration server may contact NFs (e.g., each WTRU's serving AMF or UDM) to gather WTRU's status information (e.g., connected state or idle state, subscribed PLMN, and/or frequency, etc.).

The WTRU's status information may be included in the information received from ML capability repository per 516. This information from the WTRU may be conveyed to the AMF either over a protected interface (e.g., NAS) and/or protected for integrity, replay, and/or for confidentiality (e.g., optionally). Based on WTRU's status information, the server may update the list of candidate WTRUs.

At 524, the server may send a request for information of supported feature (e.g., dataset features) for the requested analytic service ID. The request may include the requested ML model for the requested analytic service ID. This information from the AMF may be conveyed to the WTRU/RAN node either over a protected interface (e.g., NAS or N2 session) or protected for integrity, replay, and/or for confidentiality (e.g., optionally).

At 528, after receiving the request, the WTRU and/or RAN nodes may respond with a list of available features for data collection for the requested ML model. If the requested ML model is not included in the request, the WTRU and/or RAN nodes may respond with supported ML model for the requested analytic service ID and/or a list of available features for data collection for each supported ML model.

Per the WTRU's circumstance (e.g., location, channel qualities, frequency, and/or weather, etc.), some features may not be available for data collection. Those features not available for data collection will not be included in the list of available features for data collection.

At 532, the server may determine an ML model with features for the requested analytic service ID. The server may determine AI/ML collaboration level and/or a list of target WTRUs and/or RAN Node(s) (e.g., based on the received feature list available for data collection and indication whether configured ML model is supported).

The determined AI/ML collaboration level may be decided according to the requested analytic service information with additional information (e.g., ML model download and training from 3rd party server), configured ML model for each analytic ID, and the capability of WTRU and RAN Node (e.g., ML model, feature list, and/or support of configured ML model).

In an example, AI/ML collaboration server may utilize preconfigured ML model collaboration level. For example, the server may provide an indication whether ML model may be downloaded, and/or an indication whether ML model training for the WTRU/RAN node may be performed outside WTRU/RAN Node. The server may utilize the WTRU/RAN node's capability to decide AI/ML collaboration level.

If the WTRU/RAN Node may execute any ML model dynamically configurable, AI/ML may consider customized ML model transfer to the WTRU and any dynamic updates per WTRU/RAN Node's condition.

If the WTRU/RAN node may execute only pre-configured ML model with some features, the collaboration level with the WTRU/RAN node is to utilize the WTRU/RAN node's preconfigured ML model for inference. When some of features for the requested analytic service is not supported in the preconfigured ML model of WTRU/RAN node, the WTRU/RAN node may not be selected by the server. The server may update the list of features based on the supported feature by WTRU/RAN node received at 528.

At 536, when the decided AI/ML collaboration level may include the delivery of the configured ML model to the WTRU and/or RAN node, the server may assign an ML model ID for the WTRU and/or an ML model ID for the RAN node. This may indicate that the decided ML model for AI/ML collaboration with a WTRU and/or RAN node. The server may store the ML model at the ML model repository with ML model ID so that the WTRU and/or RAN node may download the configured ML model using ML model ID from the ML model repository.

At 540, the Server may send a request for AI/ML service. The request may include requested analytic service ID for ML inference and/or AI/ML collaboration level. The request may include ML model information for the analytic service ID. When the ML model is to be downloaded, the ML model ID, and/or information for ML model delivery (e.g., server IP address, ML model repository's address, and/or relevant PDU session information if downloaded via UP, etc.) may be included together. When the ML model is trained outside the WTRU/RAN node, information for data collection (e.g., ML model training server's address, relevant PDU session information if transferred via UP, and/or time information for data collection, etc.) may be included together. In the request for ML model inference, the requested time for data collection on ML model inference may be included.

In an example, WTRU/RAN node may receive separate request for ML model training and/or ML model inference. In this case, after a WTRU/RAN node downloaded a ML model from ML model repository using ML model ID, the WTRU may receive another request for ML model inference. The request may include time for data collection on ML model inference.

At 544, if the ML model is downloaded via UP and/or training data transfer is performed via UP, the associated PDU session may be established, if needed.

At 548, the WTRU and/or RAN Node may send training data to the ML model training server (e.g., via CP, UP, and/or N2 connection with AMF, etc.) based on configuration at 540.

For the WTRU's ML model training, as Option 1a, at 552, the WTRU may download the ML model with ML model ID from the ML model repository if indicated at 540. At 556, the WTRU may perform ML model training for the requested analytic service ID. In this case, WTRU may use a preconfigured ML model inside and/or a downloaded ML model from the ML model repository as configured at 540.

As Option 1b, at 560, the ML model training server may train ML model with ML model ID assigned for the WTRU using the data transferred at 548. The trained ML model may be updated in the ML model repository with the ML model ID assigned for WTRU's ML Model. After training, at 564, the WTRU may download the ML model with ML model ID from the ML model repository, if indicated at 540.

For RAN Node's ML model training, as Option 2a, at 568, RAN node may download the ML model with ML model ID from the ML model repository if indicated at 540. And at 572, the RAN node may perform ML model training for the requested analytic service ID. In this case, the RAN node may use a preconfigured ML model inside or a downloaded ML model from the ML model repository as configured at 540.

As Option 2b, at 576, the ML model training server may train the ML model with ML model ID assigned for the RAN node using the data transferred at 548. The trained ML model may be updated in ML model repository with the ML model ID assigned for RAN node's ML model. After training, at 580, the RAN node may download the ML model with ML the model ID from the ML model repository, if indicated at 540.

At 584, the WTRU and/or RAN node may perform ML model inference based on the request at 540. For ML model inference, the WTRU and/or the RAN node may collect data in the requested time for data collection on ML model inference. The WTRU may use the collected data for ML model inference. For some analytic service, the WTRU's ML model inference result may be used as input for RAN node's ML model inference, vice versa based on coordination by AI/ML collaboration server (e.g., sent the same request at 540).

At 588, the WTRU and/or the RAN node may respond AI/ML collaboration server with ML inference result for requested analytic service ID at 540.

At 592, based on the WTRU and/or the RAN node's inference result, the AI/ML collaboration server may derive analytic information for the requested analytic service by the service consumer.

At 596, the analytic information may be provided to service consumer as a response to the analytic service request.

What is claimed is:

1. A wireless transmit/receive unit (WTRU) comprising:
a processor and memory, wherein the processor is configured to:
receive, from a network, a first request for information associated with data collection and artificial intelligence or machine learning (AI/ML) model capabilities for performing a collaborative analytic service, wherein the collaborative analytic service is associated with an AI/ML model identified by an analytic service identifier (ID);
send, to the network, a response to the first request, the response comprising the information associated with data collection and the AI/ML model capabilities for performing the collaborative analytic service;
receive, from the network, a second request to perform the collaborative analytic service using the AI/ML model identified by the analytic service ID, wherein the second request comprises AI/ML collaboration level information associated with the AI/ML model identified by the analytic service ID, wherein the AI/ML collaboration level information indicates how the AI/ML model identified by the analytic service ID is configured or trained at the WTRU; and
send, to the network, results of inference performed using the AI/ML model identified by the analytic service ID.

2. The WTRU of claim 1, wherein the processor is configured to:
train the AI/ML model identified by the analytic service ID based on the collaboration level information; or
receive the AI/ML model identified by the analytic service ID based on the collaboration level information.

3. The WTRU of claim 1, wherein the processor is configured to:
send, to a model training server, data for AI/ML model training based on the analytic service ID and the AI/ML collaboration level; and
receive, from the model training server, an AI/ML model ID, wherein the AI/ML model ID is based on the received data for AI/ML model training and on the analytic service ID.

4. The WTRU of claim 1, wherein the AI/ML model capabilities comprise one or more of a list of supported analytic service IDs, a list of AI/ML models associated with each analytic service ID, an indication of supporting a configurable AI/ML model, an indication of supporting ML model download, an indication of supporting data transfer to the network or a third party server for model training, or an indication of supporting a collaborative AI/ML model.

5. The WTRU of claim 1, wherein the information associated with data collection comprises one or more of a location of the WTRU, a channel quality, frequency, or a weather condition.

6. The WTRU of claim 1, wherein the AI/ML collaboration level information can be valued by no AI/ML collaboration, AI/ML collaboration based on the AI/ML model preconfigured within the WTRU, AI/ML collaboration based on an AI/ML model downloaded to the WTRU and AI/ML model training is performed on the WTRU, or AI/ML collaboration based on an AI/ML model downloaded to the WTRU and AI/ML model training is performed by an entity other than the WTRU.

7. The WTRU of claim 1, wherein the processor is further configured to:
register the one or more features for data collection or the AI/ML model capabilities with an AI/ML repository before the network sends the first request.

8. An artificial intelligence or machine learning (AI/ML) collaboration server comprising:
a processor and memory, wherein the processor is configured to:
send, to an AI/ML repository, a first request for a list of one or more candidate wireless transmit/receive units (WTRUs), wherein the first request comprises an analytic service identifier (ID) and capabilities of the one or more candidate WTRUs for performing collaborative analytic service;
receive a first response to the first request, the first response comprising a list of candidate WTRUs comprising the analytic service ID and the capabilities of the one or more candidate WTRUs for performing collaborative analytic service;
send, to a candidate WTRU from the list of candidate WTRUs, a second request for information associated with information associated with data collection and AI/ML model capabilities for performing collaborative analytic service;
receive, from the candidate WTRU, a second response to the second request, the second response comprising the information associated with data collection and the AI/ML model identified by the analytic service ID;
determine an AI/ML model for collaborative analytic service based on the one or more of features for data collection and the AI/ML models capable for supporting the AI/ML model identified by the analytic service ID;
send, to the candidate WTRU, a third request to perform collaborative analytic service using the AI/ML model identified by the analytic service ID, wherein the third request comprises AI/ML collaboration level information associated with the AI/ML model identified by the analytic service ID, wherein the AI/ML collaboration level information indicates how the AI/ML model identified by the analytic service ID is configured or trained at the WTRU;
receive, from the candidate WTRU, results of inference performed using the AI/ML model identified by the analytic service ID;
compute analytics information based on the received results of inference; and
send the computed analytics information to a service consumer.

9. The AI/ML collaboration server of claim 8, wherein the first request further comprises one or more of a network slice, a data network name (DNN), a time period for data collection for inference, a list of WTRU candidates, a service area, or an application identifier (ID).

10. The AI/ML collaboration server of claim 8, wherein the first response further comprises one or more of a list of supported analytic IDs, a list of AI/ML models per analytic ID with associated information, an indication of supporting configurable AI/ML models, an indication of supporting AI/ML model download, an indication of supporting data transfer to a network or a third party server for model training, or an indication of supporting collaborative AI/ML models.

11. The AI/ML collaboration server of claim 8, wherein the processor is further configured to:
send, to the candidate WTRU, an AI/ML collaboration level based on a type of AI/ML model associated with the analytic service ID.

12. The AI/ML collaboration server of claim 8, wherein the AI/ML model capabilities comprise one or more of a list of supported analytic service IDs, a list of AI/ML models associated with each analytic service ID, an indication of supporting a configurable AI/ML model, an indication of supporting ML model download, an indication of supporting data transfer to the network or a third party server for model training, or an indication of supporting a collaborative AI/ML model.

13. The AI/ML collaboration server of claim 8, wherein the information associated with data collection comprises one or more of a location of the WTRU, a channel quality, frequency, or a weather condition.

14. The AI/ML collaboration server of claim 8, wherein the processor is further configured to:
receive an analytics service request from the service consumer, wherein the consumer request comprises one or more of quality of service (QoS) requirements, requirements for accuracy, or latency.

15. The AI/ML collaboration server of claim 13, analytics service request further comprises additional parameters associated with the target analytic service, the additional parameters comprising one or more of requested NW slice information, a requested data network name (DNN), a requested time period for data collection for inference, a requested service area, requested list of UE(s), or an application identifier (ID).

16. A method implemented by a wireless transmit/receive unit (WTRU), the method comprising:
receiving, from a network, a first request for information associated with data collection and AI/ML model capabilities for performing a collaborative analytic service, wherein the collaborative analytic service is associated with an AI/ML model identified by an analytic service identifier (ID);
sending, to the network, a response to the first request, the response comprising the information associated with data collection and the AI/ML model capabilities for performing the collaborative analytic service;
receiving, from the network, a second request to perform the collaborative analytic service using the AI/ML model identified by the analytic service ID, wherein the second request comprises AI/ML collaboration level information associated with the AI/ML model identified by the analytic service ID, wherein the AI/ML collaboration level information indicates how the AI/ML model identified by the analytic service ID is configured or trained at the WTRU; and
sending, to the network, results of inference performed using the AI/ML model identified by the analytic service ID.

17. The method of claim 15, further comprising:
training the AI/ML model identified by the analytic service ID based on the collaboration level information; or
receiving the AI/ML model identified by the analytic service ID based on the collaboration level information.

18. The method of claim 15, further comprising:
sending, to a model training server, data for AI/ML model training based on the analytic service ID and the AI/ML collaboration level; and
receiving, from the model training server, an AI/ML model ID, wherein the AI/ML model ID is based on the received data for AI/ML model training and on the analytic service ID.

19. The method of claim 15, wherein the AI/ML model capabilities comprise one or more of a list of supported analytic service IDs, a list of AI/ML models associated with each analytic service ID, an indication of supporting a configurable AI/ML model, an indication of supporting ML model download, an indication of supporting data transfer to the network or a third party server for model training, or an indication of supporting a collaborative AI/ML model.

20. The method of claim 15, wherein the information associated with data collection comprises one or more of a location of the WTRU, a channel quality, frequency, or a weather condition.
